(19) United States
(12) Patent Application Publication
(10) Pub. No.: US 2007/0203277 A1
(43) Pub. Date: Aug. 30, 2007

(54) Highly-neutralized ethylene copolymers and their use in golf balls

(76) Inventor: John Chu Chen, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/789,831

(22) Filed: Apr. 25, 2007

Related U.S. Application Data
(63) Continuation-in-part of application No. 11/201,893, filed on Aug. 11, 2005.
Application No. 11/201,893 is a continuation-in-part of application No. 10/269,341, filed on Oct. 11, 2002, now Pat. No. 6,953,820.
Application No. 10/269,341 is a continuation-in-part of application No. 09/691,284, filed on Oct. 18, 2000, now Pat. No. 6,653,382.
Application No. 09/691,284 is a continuation-in-part of application No. 09/558,894, filed on Apr. 27, 2000, now Pat. No. 6,777,472.
Application No. 09/558,894 is a continuation-in-part of application No. 09/422,142, filed on Oct. 21, 1999, now abandoned.
(60) Provisional application No. 60/105,065, filed on Oct. 21, 1998.
(60) Provisional application No. 60/105,232, filed on Oct. 21, 1998.
(60) Provisional application No. 60/105,193, filed on Oct. 22, 1998.
(60) Provisional application No. 60/105,181, filed on Oct. 22, 1998.

(51) Int. Cl. C08K 5/09; A63B 37/00; C08K 5/00

(52) U.S. Cl. 524/322; 473/351; 524/284; 524/300

(57) ABSTRACT

Provided are thermoplastic compositions having tailored PGA compression and optionally low moisture sensitivity. The thermoplastic compositions may be used in golf balls and golf ball components. The thermoplastic compositions comprise melt-processible, highly-neutralized ethylene acid copolymers and one or more aliphatic, mono-functional organic acids, in which greater than 50 mol % of all the acid groups in the ethylene acid copolymer and in the organic acid or acids are neutralized. Thermoplastic compositions comprising at least 30 equivalent % Zn²⁺ or Ca²⁺ as counterions exhibit surprising resistance to moisture absorption.

### CROSS-REFERENCES TO RELATED APPLICATIONS

This application claims priority under 35 U.S.C. § 120 as a continuation-in-part of U.S. patent application Ser. No. 11/201,893, filed on Aug. 11, 2005, which in turn is a continuation-in-part of U.S. Pat. No. 6,953,820, filed on Oct. 11, 2002, which in turn is a continuation-in-part of U.S. Pat. No. 6,653,382, filed on Oct. 18, 2000, which in turn is a continuation-in-part of U.S. Pat. No. 6,777,472, filed on Apr. 27, 2000, which in turn is a continuation-in-part of U.S. patent application Ser. No. 09/422,142, filed on Oct. 21, 1999, now abandoned, which in turn claims priority to U.S. Provisional Appln. Nos. 60/105,065, filed on Oct. 21, 1998, 60/105,232, filed on Oct. 21, 1998, 60/105,193, filed on Oct. 22, 1998, and 60/105,181, filed on Oct. 22, 1998, each of which is incorporated herein by reference in its entirety.

### BACKGROUND OF THE INVENTION

1. Field of the Invention

The invention relates to polymer blends. In particular, the blends include an organic acid or salt and a copolymer of ethylene with a C₃ to C₈ α,β ethylenically unsaturated carboxylic acid copolymer, wherein the ethylene acid copolymers and organic acid are at least partially neutralized and are melt-processible. The polymer blends may be used in structural components of molded golf balls, for example.

2. Description of Related Art

Several patents and publications are cited in this description in order to more fully describe the state of the art to which this invention pertains. The entire disclosure of each of these patents and publications is incorporated by reference herein.

A family of thermoplastic materials that has found utility in golf ball components and other applications includes the ionomers of copolymers of alpha olefins, particularly ethylene, and C₃₋₈ α,β ethylenically unsaturated carboxylic acids. These ionomers have sometimes been blended with organic acids or salts of organic acids to improve their processability or their physical properties.

Highly neutralized acid copolymer compositions that are modified by the inclusion of organic acids or their salts may be hygroscopic, however. This moisture sensitivity may limit the use of such compositions in golf balls. Because the core accounts for a large portion of the weight of a golf ball, it may absorb or adsorb a substantial amount of water and the weight gain may cause the ball to exceed the maximum weight standards that are imposed by the golfer's governing authority. Also problematic are unfavorable changes in the compositions' physical properties that may accompany an increase in their water content.

It is therefore desirable to provide a thermoplastic ethylene acid copolymer composition that is minimally hygroscopic, if at all. Such a material may be useful in golf balls because of its moisture resistance and favorable physical properties. Alternatively, such compositions may be useful as a moisture barrier for the protection of other parts of the golf ball that may be formed from more hygroscopic materials.

### SUMMARY OF THE INVENTION

Described herein are moisture-resistant compositions comprising:
(a) at least one aliphatic, mono-functional organic acid comprising up to 36 carbon atoms, wherein the organic acid is saturated and linear; and
(b) an ethylene acid copolymer consisting essentially of copolymerized monomers of ethylene and from 4 to 30 weight % of copolymerized comonomers of at least one C₃ to C₈ α,β ethylenically unsaturated carboxylic acids, based on the total weight of the ethylene dipolymer;
   wherein greater than 50 mole % of all the acid moieties of (a) and (b) are neutralized to form salts; wherein the cations of the salts comprise at least about 75 equivalent % of Ca²⁺ cations or at least about 30 equivalent % of Zn²⁺ cations, based on the total number of moles of salts; wherein pellets of the moisture-resistant composition about 3 mm long and about 2 to 3 mm in diameter gain 2.0% or less in weight after exposure to 50% relative humidity at ambient temperature for 90 days; and wherein the composition has a PGA Compression equal to or greater than 110.

Also described are moisture-resistant compositions comprising
(a) at least one aliphatic, mono-functional organic acid comprising up to 36 carbon atoms; wherein the organic acid is branched or linear; and wherein the organic acid is saturated or unsaturated; and
(b) an E/X/Y copolymer, wherein E represents copolymerized monomers of ethylene, X represents copolymerized monomers of at least one C₃ to C₈ α,β ethylenically unsaturated carboxylic acid and Y represents copolymerized monomers of at least one alkyl acrylate or alkyl methacrylate, wherein the alkyl group comprises from one to eight carbon atoms; wherein X is present in the terpolymer in an amount of from about 2 to about 25 weight % and Y is present in the terpolymer in an amount of from about 1 to about 40 weight %, based on the total weight of the E/X/Y terpolymer;
   wherein greater than 70 mol % of all the acid moieties of (a) and (b) are neutralized to form salts; wherein the cations of the salts comprise at least about 30 equivalent % of Zn²⁺ cations; wherein pellets of the moisture-resistant composition about 3 mm long and about 2 to 3 mm in diameter gain 2.0% or less in weight after exposure to 50% relative humidity for 90 days; and wherein the composition has a PGA Compression of less than 110.

Also described are compositions comprising:
(a) at least one aliphatic, mono-functional organic acid, wherein the organic acid has from 19 to 36 carbon atoms and is unsaturated and linear, or wherein the organic acid has from 6 to 36 carbon atoms and is branched and saturated or unsaturated; and
(b) an E/X/Y copolymer, wherein E represents copolymerized comonomers of ethylene, X represents copolymerized monomers of at least one C3 to C8 α,β ethylenically unsaturated carboxylic acid and Y represents copolymerized comonomers of at least one alkyl acrylate or alkyl methacrylate, wherein the alkyl group comprises one to eight carbon atoms; and wherein X is present in the terpolymer in an amount of from 2 to 25 weight % and Y is present in the terpolymer in an amount of from 1 to 40 weight %, based on the total weight of the E/X/Y terpolymer;
   wherein greater than 70 mol % of all the acid moieties of (a) and (b) are neutralized to form salts; and wherein the composition has a PGA compression less than 110.

Also described are golf balls comprising these compositions.

### DETAILED DESCRIPTION OF THE INVENTION

The following definitions apply to the terms as used throughout this specification, unless otherwise limited in specific instances.

In this connection, the technical and scientific terms used herein have the meanings that are commonly understood by one of ordinary skill in the art to which this invention belongs. In case of conflict, the present specification, including the definitions herein, will control.

As used herein, the terms “comprises,” “comprising,” “includes,”“including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format. Optional additives as defined herein, at a level that is appropriate for such additives, and minor impurities are not excluded from a composition by the term “consisting essentially of”, however.

When a composition, a process, a structure, or a portion of a composition, a process, or a structure, is described herein using an open-ended term such as “comprising,” unless otherwise stated the description also includes an embodiment that “consists essentially of” or “consists of” the elements of the composition, the process, the structure, or the portion of the composition, the process, or the structure.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; that is, the phrase “A or B” means “A, B, or both A and B”. More specifically, a condition “A or B” is satisfied by any one of the following: A is true (or present) and B is false (or not present); A is false (or not present) and B is true (or present); or both A and B are true (or present). Exclusive “or” is designated herein by terms such as “either A or B” and “one of A or B”, for example.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

Unless stated otherwise, all percentages, parts, ratios, and like amounts, are defined by weight.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units of the specified comonomers in the specified amounts, if any. It follows as a corollary that a copolymer is not the product of a reaction mixture containing given comonomers in given amounts, unless expressly stated in limited circumstances to be such.

The term “dipolymer” refers to polymers consisting essentially of two monomers, and the term “terpolymer” refers to polymers consisting essentially of three monomers.

The term “(meth)acrylic”, as used herein, alone or in combined form, such as “(meth)acrylate”, refers to acrylic or methacrylic, for example, “acrylic acid or methacrylic acid”, or “alkyl acrylate or alkyl methacrylate”.

The term “alkyl” as used herein, alone or in combined form, refers to a branched or unbranched saturated hydrocarbon group having the formula (—CₙHₙ₊₁).

The term “saturated” refers to molecules or groups that do not contain any carbon-carbon double bonds. The term “unsaturated” refers to molecules or groups that contain at least one carbon-carbon double bond.

As used herein, the term “moisture resistant” refers to a material having a weight gain of less than 2.0%, preferably less than or equal to 1.6% weight gain, more preferably less than or equal to 1.3% weight gain, more preferably less than or equal to 1.2% weight gain, more preferably less than or equal to 1.0% weight gain, more preferably less than or equal to 0.8% weight gain, and most preferably less than or equal to 0.55% weight gain, after exposure to an atmosphere of 50% relative humidity (RH) for 90 days at room temperature (about 20-25° C.). Alternatively, the term “moisture resistant” refers to a material having a moisture vapor transmission rate (MVTR) of less than 100 (mil·gm)/(m² day), preferably less than 80 (mil·gm)/(m² day), more preferably less than 70 (mil·gm)/(m² day), even more preferably less than 50 (mil·gm)/(m² day) when measured according to ASTM F1249 at 100% RH and around 38° C.

The terms “compression” or “PGA Compression” utilized in the golf ball trade generally define the overall resistance to deflection that a golf ball undergoes when subjected to a compressive load. For example, compression indicates the amount of resistance to change in golf ball's shape upon striking. PGA compression is typically based on a scale of from 0 to 200. The lower PGA compression value, the softer the feel of the ball upon striking.

In order to assist in the determination of compression, several devices have been employed by the industry. For example, PGA compression can be determined using a golf ball compression tester produced by OK Automation, Sinking Spring, Pa. (formerly, Atti Engineering Corporation of Newark, N.J.). This machine, equipped with a Federal Dial Gauge, Model D81-C, employs a calibrated spring under a known load. The unitless value obtained by this tester typically ranges from 0 to 200. Compression measured with this instrument may be referred to as “Atti compression” and corresponds to PGA compression.

Alternative devices have also been employed to determine compression. For example, a modified Riehle Compression Machine originally produced by Riehle Bros. Testing Machine Company, Philadelphia, Pa., can be used to evaluate compression of the various components (i.e., cores, mantle cover balls, finished balls, etc.) of the golf balls. The Riehle compression device determines deformation in thousandths of an inch under a load designed to emulate the 200 pound spring constant of the Atti or PGA compression tester. Atti or PGA compression is approximately related to Riehle compression through the following equation:
Atti or PGA compression=(160−Riehle Compression).
Thus, a Riehle compression of 100 would be the same as an Atti compression of 60.

Other devices that have been used to measure golf ball compression include some that are in the form of a small press and others, such as a Whitney Tester, Whitney Systems, Inc., Chelmsford, Mass., or an Instron Device, Instron Corporation, Canton, Mass., that have been designed to make measurements that correlate or correspond to PGA or Atti compression through a set relationship or formula.

Compositions having a PGA compression equal to or greater than 110, preferably greater than 120, more preferably greater than 140, are referred to herein as “stiff” compositions. Compositions having a PGA compression less than 110, preferably less than 100, more preferably less than 80, more preferably less than 60, even more preferably less than 40, are referred to herein as “soft” compositions.

Acid Copolymers

The acid copolymers used to make the ionomers are preferably copolymers in which the acid comonomers are directly copolymerized with an alpha olefin and the copolymerized units are integral to the polymer chain. “Grafted” acid copolymers, in which the acid comonomers are added to an existing polymer chain via a post-polymerization “grafting” reaction, may also be suitable, however. The acid copolymers are preferably copolymers of an alpha olefin, preferably ethylene, with a C₃₋₈ α,β ethylenically unsaturated carboxylic acid, preferably (meth)acrylic acid.

When combined with other components as described herein, an ethylene copolymer comprising copolymerized comonomers of ethylene and from about 4 to about 30 weight % of copolymerized comonomers of one or more C₃ to C₈ α,β ethylenically unsaturated carboxylic acids is particularly useful for preparing compositions having PGA compression equal to or greater than 110 (that is, stiff compositions). Also preferred is an ethylene dipolymer consisting essentially of copolymerized comonomers of ethylene and from about 4 to about 30 weight % of copolymerized comonomers of C₃ to C₈ α,β ethylenically unsaturated carboxylic acid.

In preferred copolymers and dipolymers, the copolymerized comonomers of C₃ to C₈ α,β ethylenically unsaturated carboxylic acid(s) are present in an amount from about 8 to about 30 weight % or from about 10 to about 25 weight %, based on the total weight of the copolymer or dipolymer. In more preferred copolymers and dipolymers, the copolymerized comonomers of C₃ to C₈ α,β ethylenically unsaturated carboxylic acid-(s) comprise (meth)acrylic acid. Specific examples of preferred acid copolymers include ethylene/acrylic acid dipolymers and ethylene/methacrylic acid dipolymers.

The ethylene acid copolymers may also contain a third, “softening” monomer. The softening comonomer is believed to disrupt or otherwise lessen the crystallinity of the ethylene acid copolymer. Suitable softening comonomers include, without limitation, alkyl(meth)acrylates wherein the alkyl groups have from 1 to 8 carbon atoms, preferably from 1 to 4 carbon atoms.

The acid copolymers comprising a third softening monomer can be described as E/X/Y copolymers, wherein E represents copolymerized comonomers of ethylene, X represents copolymerized monomers of one or more C₃ to C₈ α,β ethylenically unsaturated carboxylic acids and Y represents copolymerized comonomers of one or more alkyl (meth)acrylates, wherein the alkyl group comprises one to eight carbon atoms, wherein X is present in the terpolymer in an amount from about 2 to about 25 weight % and Y is present in the copolymer in an amount from about 1 to about 40 weight %. Also preferred is an ethylene terpolymer consisting essentially of copolymerized comonomers of ethylene and from about 4 to about 30 weight % of copolymerized comonomers of C₃ to C₈ α,β ethylenically unsaturated carboxylic acid and an alkyl(meth)acrylate comonomer.

When combined with other components as described herein, an E/X/Y copolymer or terpolymer as described above is particularly useful for preparing compositions having PGA compression less than 110, that is, soft compositions.

Preferred are copolymers and terpolymers in which X is present in an amount from about 2 to 25, 5 to 20, or 5 to about 15 weight %. Also preferred are copolymers and terpolymers in which the copolymerized comonomers of the C₃ to C₈ α,β ethylenically unsaturated carboxylic acid(s) comprise (meth)acrylic acid. Also preferred are copolymers and terpolymers in which Y is present in an amount from about 5 to 40, 10 to 30, and 5 to about 35 weight %.

Specific examples of suitable terpolymers include, without limitation, ethylene/acrylic acid/n-butyl acrylate, ethylene/acrylic acid/iso-butyl acrylate, ethylene/acrylic acid/methyl acrylate, and ethylene/acrylic acid/ethyl acrylate terpolymers; ethylene/acrylic acid/n-butyl methacrylate, ethylene/acrylic acid/iso-butyl methacrylate, ethylene/acrylic acid/methyl methacrylate, and ethylene/acrylic acid/ethyl methacrylate terpolymers; ethylene/methacrylic acid/n-butyl acrylate, ethylene/methacrylic acid/iso-butyl acrylate, ethylene/methacrylic acid/methyl acrylate, and ethylene/methacrylic acid/ethyl acrylate terpolymers; and ethylene/methacrylic acid/n-butyl methacrylate, ethylene/methacrylic acid/iso-butyl methacrylate, ethylene/methacrylic acid/methyl methacrylate, and ethylene/methacrylic acid/ethyl methacrylate terpolymers.

Ethylene acid copolymers may be made by any suitable method. Ethylene acid copolymers with high levels of acid may be difficult to prepare in continuous polymerizers because of monomer-polymer phase separation. This difficulty can be avoided however by use of “co-solvent technology” as described in U.S. Pat. No. 5,028,674 or by employing somewhat higher pressures than those at which copolymers with lower acid can be prepared.

Ionomers

Ionomers are ionic copolymers that are obtained after neutralization of an acid copolymer. Neutralizing agents, which for the purposes of this application are basic compounds containing metal cations such as sodium or zinc ions, are used to neutralize at least some portion of the acidic groups in the acid copolymer.

Suitable unmodified ionomers are prepared from the acid copolymers described above by methods known in the art of preparing ionomers. The term “unmodified”, as used herein, refers to ionomers that are not blended with any material that has a significant effect on the properties of the unblended ionomer.

Suitable ionomers are melt processible and include partially or completely neutralized acid copolymers, particularly copolymers prepared from copolymerization of ethylene and acrylic acid or methacrylic acid and optionally other comonomers. The unmodified ionomers may be neutralized to any level that does not result in an intractable (not melt processible) polymer, or a material that does not have useful physical properties. Preferably, about 15 to about 90%, more preferably about 50 to about 75% of the acid moieties of the ethylene acid copolymer are neutralized.

Suitable counterions for ionomers include one or more of an alkali metal, an alkaline earth metal, or a transition metal cation. Preferred cations include, without limitation, lithium, sodium, potassium, magnesium, calcium, barium, zinc, and combinations of two or more of lithium, sodium, potassium, magnesium, calcium, barium and zinc. For moisture resistant compositions, calcium and zinc ionomers are particularly preferred. Combinations of calcium or zinc with other cations, including, for example, combinations of zinc and magnesium, may also be preferable for moisture-resistant compositions.

Organic Acids and Salts

Suitable organic acids include, without limitation, monofunctional organic acids having fewer than 36 carbon atoms, optionally substituted with from one to three substitutents independently selected from C₁ to C₈ alkyl groups. The organic acids may be saturated or unsaturated, and, if unsaturated, may include more than one carbon-carbon double bond. The term “mono-functional” refers to acids with one carboxylic acid moiety. The suitable organic acids include C₄ to C₃₆ (for example C₁₈), more particularly C₆ to C₂₆, and even more particularly C₆ or C₁₂ or C₁₈ to C₂₂ acids. In some cases, C₁₉ to C₃₆ acids are preferred.

Specific examples of suitable organic acids include, but are not limited to, caproic acid, caprylic acid, capric acid, lauric acid, stearic acid, isostearic acid, behenic acid, erucic acid, oleic acid, iso-oleic acid, and linoleic acid. Naturally derived organic fatty acids such as palmitic, stearic, oleic, erucic, behenic acids, and mixtures thereof may also be employed.

As is well known in the art, commercial grades of organic acids may include a number of structurally different organic acids of varying lesser amounts. As used herein, unless otherwise specified in limited circumstances, a composition that comprises a named acid may also include other acids that are present in commercial grades of the named acid, at levels that are proportional to their levels in the commercial grade. Furthermore, when the transitional term “consisting essentially of” is applied to compositions that comprise a named acid, other acids that are present in commercial grades of the named acid, at levels that are proportional to their levels in the commercial grade, are not excluded from the composition.

Saturated acids of particular note include stearic acid and behenic acid. Saturated linear organic acids (for example stearic acid and behenic acid) are acids comprising only one CH₃ (methyl) and no CH (methenyl) moieties.

Unsaturated linear organic acids (for example oleic acid and erucic acid) are acids that have only one CH₃ moiety and at least one carbon-carbon double bond. They include any number of CH₂ (methylene) groups, within the molecular weight limits set forth above. Monounsaturated acids contain one carbon-carbon double bond.

Acids substituted with from one to three C₁ to C₈ alkyl substitutents, preferably methyl groups, are referred to herein as branched acids. Saturated, branched organic acids are acids comprising at least one CH (methenyl) moiety and at least two CH₃ (methyl) moieties. Of note are saturated, branched organic acids substituted with one C₁ to C₈ alkyl group.

Also of note is an organic acid that is branched and saturated, preferably having from 6 to 24 carbon atoms, such as iso-stearic acid. The C₁₈ saturated branched organic acid, “iso-stearic acid,” also known as isooctadecanoic acid or 16-methyl-heptadecanoic acid, is particularly preferred. Iso-stearic acid is commercially available, for example, from Arizona Chemical, Jacksonville, Fla., under the tradename Century™ 1115. This material is described as a mixture of about 55% C₁₈ saturated, branched acid, about 20% of C₁₈ cyclic acid, about 10% C₂₀ saturated, branched organic acid, and lesser amounts of saturated linear acids of various carbon counts.

Unsaturated branched acids are acids comprising at least one carbon-carbon double bond, at least two CH₃ (methyl) moieties and at least one CH (methenyl) moiety. They may include any number of CH₂ (methylene) groups, within the molecular weight limits set forth above. Of note are unsaturated, branched organic acids substituted with one C₁ to C₈ alkyl group.

Also of note is an organic acid that is branched and unsaturated, preferably having from 6 to 24 carbon atoms, such as the C₁₈ mono-unsaturated methyl-branched organic acid known as “iso-oleic acid.” Iso-oleic acid is commercially available, for example, from Arizona Chemical, Jacksonville, Fla., under the tradename Century™ 1164. This material is described as a mixture of about 76% iso-oleic acids, about 11% oleic acids, 8% saturated fatty acids and 5% miscellaneous fatty acids.

While it may be useful for the organic acids (and their salts) to have a low volatility when being melt-blended with the acid copolymer or ionomer, volatility has been found to not be limiting when preparing blends with high nominal neutralization levels, particularly near to or at 100%. At 100% nominal neutralization (i.e., sufficient basic compound is added such that all acid moieties in the copolymer and organic acid are nominally neutralized), volatility simply is no longer an issue. As such, organic acids with relatively low molecular weights can be used. It is preferred, however, that the organic acid (or salt) be non-volatile and non-migratory. Non-volatile organic acids and salts do not volatilize at temperatures of melt blending of the agent with the acid copolymer. Non-migratory organic acids and salts do not bloom to the surface of the polymer under normal storage conditions, which typically approximate ambient meteorological conditions.

The salts of the organic acids have one or more of a wide variety of cations, particularly including the barium, lithium, sodium, zinc, bismuth, potassium, strontium, magnesium or calcium cations.

Process for Making the Compositions

Melt-processible, modified ionomer blends as described herein may be produced by heating a mixture of the carboxylic acid copolymer(s) or ionomer(s), the organic acid(s) or salt(s) thereof, and a basic compound capable of neutralizing the acid moieties of the acid copolymer and/or the organic acid. For example, the components of the composition can be mixed by
(a) Melt-blending ethylene α,β-ethylenically unsaturated C₃₋₈ carboxylic acid copolymer(s) or ionomer(s) thereof as described above that are not neutralized to the level of intractability with one or more organic acids as described above or salts thereof, and concurrently or subsequently
(b) Adding a sufficient amount of a basic compound capable of neutralization of the acid moieties (including those in the acid copolymer and in the organic acid), preferably to nominal neutralization levels greater than 50, 60, 70, 80, 90%, to near 100%, or to 100% or above.
   The term “intractable” refers to an ionomer that is not melt-processible. Preferably the organic acids or salts thereof are present in a range having a lower limit of about 2 or 4 to an upper limit of about 15, 20, 30, 40 or 50 weight % of the total composition.

Melt-blending acid copolymers and organic acids and neutralizing (either simultaneously or subsequently) is a way to prepare the composition without the use of an inert diluent and still maintain melt processibility in the intended neutralization range. For example, an acid copolymer blended with organic acid(s) can be nominally neutralized to over 50%, or 60%, or 70%, or 80%, or 90%, or about 100% or to 100% without losing melt processibility. In addition, nominal neutralization to about 100% or to 100% reduces the volatility of the organic acids.

The acid copolymer(s) or unmodified, melt-processible ionomer(s) can be melt-blended with the organic acid(s) or salt(s) and other polymers in any manner known in the art. For example, a salt and pepper blend of the components can be made and the components can then be melt-blended in an extruder.

The melt-processible, acid copolymer/organic-acid-or-salt blend can be treated with the basic compound(s) by methods known in the art, such as melt-mixing. For example, a Werner & Pfleiderer twin-screw extruder can be used to mix the acid copolymer and the organic acid and simultaneously treat them with the basic compound. It is desirable that the mixing be conducted so that the components are intimately mixed, allowing the basic compound to neutralize the acidic moieties in the other components.

Sufficient basic compound is added to the blend so that, in aggregate, the desired nominal neutralization level may be achieved. The term “nominal neutralization level”, as used herein, refers to the theoretical level of neutralization of a mixture of an acid copolymer and an organic acid when a certain amount of a basic metal compound capable of neutralizing the acidic groups in the acid copolymer and the organic acid is added to the mixture. The amount of basic compound that is sufficient to neutralize a given amount of acid copolymer and a given amount of organic acid to a predetermined “nominal” level may be calculated according to standard stoichiometric principles. Likewise, should the mixture further comprise an ionomer or a salt of an organic acid, standard stoichiometric principles will also govern the calculation of the amount of base that is sufficient to neutralize this more complicated mixture to a predetermined “nominal” level. Nominal neutralization levels greater than 50, 60, 70, 80, or 90%, 100%, or about 100%, or nominal neutralization levels of 100% of all acid moieties in the composition are preferred.

Suitable basic compounds contain cations of alkali metals, such as lithium, sodium or potassium, transition metal cations or alkaline earth metal cations and mixtures or combinations of such cations. Basic compounds of note include formates, acetates, nitrates, carbonates, hydrogen carbonates, oxides, hydroxides or alkoxides of the ions of alkali metals, and formates, acetates, nitrates, oxides, hydroxides or alkoxides of the ions of alkaline earth metals and transition metals. Of particular note are basic compounds comprising zinc or calcium such as the corresponding formate, acetate, hydroxide, oxide, alkoxide, etc.

The basic compounds can be added neat to the acid copolymer or ionomer thereof and the organic acid or salt thereof. The basic compound may also be premixed with a polymeric material, such as an acid copolymer, to form a “masterbatch” that can be added to the acid copolymer or ionomer thereof and the organic acid or salt thereof.

Actual neutralization levels can be determined using infrared spectroscopy by comparing an absorption peak attributable to carboxylate anion stretching vibrations at 1530 to 1630 cm⁻¹ and an absorption peak attributable to carbonyl stretching vibrations at 1690 to 1710 cm⁻¹, after compensation for any difference in extinction coefficients for these peaks.

Moisture Resistant Thermoplastic Compositions

The moisture resistant thermoplastic materials are compositions that comprise (a) the acid copolymers or the melt processible ionomers as described above and (b) one or more aliphatic, mono-functional organic acids or salts thereof as described above, wherein greater than about 50%, or 60%, or 70%, or 80%, or 90%, or near 100%, or 100% of all the acid of (a) and of (b) is neutralized. Preferably, greater than about 50%, more preferably greater than 60%, more preferably greater than 70%, more preferably greater than 80%, more preferably greater than about 90%, and even more preferably nearly 100% of all the acid or 100% of all the acid moieties of (a) and (b) are nominally neutralized by a cation source. These moisture resistant compositions may be made by melt-blending and neutralization, for example, as described above.

For the moisture resistant compositions, calcium and/or zinc ionomers and salts of the organic acids are particularly preferred. While other cations may be present in the blended composition, the equivalent percentage of calcium and/or zinc salts in the final blended ionomeric composition is preferably at least about 30 equivalent %, preferably at least about 40 equivalent %, more preferably at least about 60 equivalent %, more preferably at least about 70 equivalent %, even more preferably at least about 80 equivalent %, and most preferably at least about 90 equivalent % based on the total salts present in the blended composition. Without wishing to be held to any theory, it is believed that the presence of Ca and/or Zn cations in the preferred ranges provides moisture resistance to these compositions.

In stiffer moisture resistant compositions, the ethylene acid copolymer consists essentially of copolymerized monomers of ethylene and from 4 to 30 weight % of copolymerized comonomers of at least one C₃ to C₈ α,β ethylenically unsaturated carboxylic acid.

For softer moisture resistant compositions, the crystallinity of the acid copolymer is disrupted by inclusion of a softening monomer or other means. Stated alternatively, the acid copolymer is an E/X/Y copolymer in which the amount of Y is sufficient to accomplish this disruption to an adequate degree. Preferably, the organic acid is melt blended with this acid copolymer and either concurrent to blending or subsequent to blending the acid copolymer blend is highly neutralized to a level of greater than or equal to about 50% neutralization, preferably greater than or equal to about 60%, more preferably greater than or equal to about 70%, more preferably greater than or equal to about 80%, more preferably greater than or equal to about 90%, even more preferably to nearly 100%, or to 100% of all acid in the blend.

Preferably, the organic acid includes more than 6 carbon atome. Also preferred are compositions in which the organic acid includes from 6 to 17 carbon atoms, from 23 to 36 carbon atoms, or from 18 to 22 carbon atoms. Stearic acid and behenic acid are particularly preferred.

The resulting moisture-resistant thermoplastic composition can be melt-blended with other components to produce end products. For example, the moisture-resistant material may be melt-blended with components employed in co-pending U.S. application Ser. No. 09/422,142 to make one-piece, two-piece, wound, and multilayer golf balls. The components used with the resulting highly neutralized, melt-processible acid copolymer in this case include thermoplastic polymer components selected from polyether-esters, polyether-amides, polyether-urea, elastomeric polyolefins, styrene diene block copolymers, thermoplastic polyurethanes, polyamide, polyester, polyolefins, ethylene copolymers, functionalized polymers with epoxy functionality or anhydride functionality, EPDM, mPE, ground up thermoset rubber, etc.; and fillers.

In another embodiment, blends of organic acid modified copolymers can be used. For example, blends suitable for the purposes described herein can be obtained by combining individual organic acid-modified copolymers obtained as described herein, each individually suitable for use, to obtain a copolymer blend. Alternatively, blends of the acid copolymers or unmodified ionomers can be modified by addition of organic acid as described herein. Alternatively, it may be desirable to blend an acid copolymer or unmodified ionomer with a modified copolymer or copolymer blend. Still alternatively, a blend may be obtained using components that individually do not have the properties described herein, but result in a blend suitable for use as described herein. Blends are not limited to two-component blends, and may be blends of up to 5 different copolymer components. Preferably the blends include 2 or 3 different copolymer components, and most preferably 2 different copolymer components.

Stiff Moisture Resistant Thermoplastic Composition

Compositions wherein the combined salts of the ionomer (especially ionomers of E/X copolymers or dipolymers) and organic acid (especially wherein the organic acid is saturated and linear) comprise at least about 75 equivalent % Ca counterions or at least about 30 equivalent %, preferably at least about 40%, more preferably at least about 50%, more preferably at least about 60%, more preferably at least about 70%, more preferably at least about 80% Zn counterions are particularly useful as stiff moisture resistant compositions.

Of note is a composition comprising an organic acid that is saturated and linear. Of note is a composition comprising a saturated, linear organic acid having from 6 to 17 carbon atoms. Of note is a composition comprising a saturated, linear organic acid having from 23 to 36 carbon atoms. Of note is a composition comprising a saturated, linear organic acid having from 18 to 22 carbon atoms.

A preferred composition is one wherein the organic acid comprises stearic acid, behenic acid or a mixture thereof, the overall salt of the composition comprises at least about 75 equivalent % calcium counterions and the neutralized organic acid is present in an amount of from about 4 to about 30 weight %.

Of note is the composition comprising from about 4 to about 30 weight % of zinc stearate, zinc behenate or a mixture thereof.

Of note is the composition wherein the organic acid comprises stearic acid, behenic acid or a mixture thereof, the overall salt of the composition comprises at least about 30 equivalent % zinc counterions and the neutralized organic acid is present in from about 4 to about 30 weight %.

Soft Moisture Resistant Thermoplastic Composition

Compositions wherein the combined salts of the ionomer (especially ionomers of E/X/Y copolymers or terpolymers) and the organic acid (especially wherein the organic acid is other than saturated and linear, such as an organic acid that is branched and saturated, branched and unsaturated, or linear and unsaturated) wherein the salts comprise at least about 30 equivalent %, preferably at least about 40%, more preferably at least about 50%, more preferably at least about 60%, more preferably at least about 70%, more preferably at least about 80% zinc counterions are particularly useful as soft moisture resistant compositions.

Of note is a composition comprising oleic acid. Of note is a composition comprising an organic acid that is linear and unsaturated, having from 19 to 36 carbon atoms, such as erucic acid. Of note is a composition comprising an organic acid that is linear and unsaturated, having from 6 to 17 carbon atoms.

Of note is the moisture-resistant composition wherein the neutralized organic acid is present in from about 4 to about 50 weight % of the composition.

Of note is the moisture-resistant composition comprising an organic acid or salt that is branched and saturated. Of note are such compositions comprising an organic acid or salt having from 6 to 24 carbon atoms, such as those wherein the organic acid comprises iso-stearic acid.

Of note is the moisture-resistant composition comprising an organic acid or salt that is branched and unsaturated. Of note are such compositions comprising an organic acid or salt having from 6 to 24 carbon atoms, such as those wherein the organic acid comprises iso-oleic acid.

Of note is the moisture-resistant composition comprising an organic acid or salt that is linear and unsaturated. Of note are such compositions comprising an organic acid or salt having from 19 to 36 carbon atoms, such as those wherein the organic acid comprises erucic acid. Also of note is the composition wherein the organic acid comprises oleic acid.

Also of note is the composition comprising an organic acid or salt having from 6 to 17 carbon atoms.

Soft Thermoplastic Composition

Compositions wherein the combined salts of the ionomer (especially ionomers of E/X/Y copolymers or terpolymers) and an organic acid, wherein the organic acid has from 19 to 36 carbon atoms and is unsaturated and linear, or wherein the organic acid has from 6 to 36 carbon atoms and is branched and saturated or unsaturated, and wherein greater than 70 mol % of all the acid moieties are neutralized are particularly useful as soft compositions.

Of note is the composition wherein the organic acid comprises erucic acid.

Of note is the composition wherein the organic acid has from 6 to 36 carbon atoms, or from 6 to 24 carbon atoms, and is branched and saturated. Of note is the composition wherein the organic acid comprises iso-stearic acid.

Of note is the composition wherein the organic acid has from 6 to 36 carbon atoms, or from 6 to 24 carbon atoms, and is branched and unsaturated. Of note is the composition wherein the organic acid comprises iso-oleic acid.

Optional Filler

Various optional fillers may be added to compositions to reduce cost, to increase or decrease weight, to reinforce the material, adjust the density, flex modulus, mold release, and/or melt flow index of a layer, and the like. The amount of filler employed is primarily a function of weight requirements and distribution. The fillers may be used to adjust the properties of the layer, reinforce the layer, or for any other purpose.

The filler may be chosen to impart additional density to compositions of the previously described components, the selection being dependent upon the type of golf ball desired (i.e., one-piece, two-piece, wound or multilayer), as will be more fully detailed below. The filler may be included in one or more layers of the golf ball. Generally, the filler will be inorganic, having a density from about 4 grams/cubic centimeter (g/cc), or from about 5 g/cc, to about 10 g/cc, or higher and may be present in amounts between 0 and about 60 weight % based on the total weight of the composition. Examples of useful fillers include titanium, tungsten, aluminum, bismuth, nickel, molybdenum, iron, steel, lead, copper, brass, boron, boron carbide whiskers, bronze, cobalt, beryllium, zinc, tin, metal oxides including zinc oxide, iron oxide, aluminum oxide, tin oxide, titanium oxide, magnesium oxide, zinc oxide and zirconium oxide, as well as other well known corresponding salts and oxides thereof. Other preferred fillers include barium sulfate, lead silicate, tungsten carbide, limestone (ground calcium/magnesium carbonate) and ground flash filler. It is preferred that the filler materials be non-reactive or almost non-reactive.

Fillers may be employed in a finely divided form, for example, in a size generally less than about 20 mesh, preferably less than about 100 mesh U.S. standard size, except for fibers and flock, which are generally elongated. Flock and fiber sizes should be small enough to facilitate processing. Filler particle size will depend upon desired effect, cost, ease of addition, and dusting considerations.

Other Optional Components

The compositions may additionally comprise small amounts of optional materials that are commonly used and well known in the art of golf ball design and fabrication. Such materials include conventional additives used in polymeric materials including plasticizers, stabilizers including viscosity stabilizers and hydrolytic stabilizers, primary and secondary antioxidants such as for example Irganox™ 1010, ultraviolet ray absorbers and stabilizers, anti-static agents, dyes, pigments or other coloring agents, fire-retardants, lubricants, processing aids, slip additives, antiblock agents such as silica or talc, release agents, and/or mixtures thereof. Additional optional additives can include: inorganic fillers as described below; acid copolymer waxes, such as for example Honeywell wax AC540; titanium dioxide (TiO₂), which is used as a whitening agent; optical brighteners; surfactants; and other components known in the art of golf ball manufacture to be useful but not critical to golf ball performance and/or acceptance. These additives and others suitable for use in the compositions of the invention are described in the Kirk-Othmer Encyclopedia of Chemical Technology, 5^{th} Edition, John Wiley & Sons (New Jersey, 2004).

These conventional ingredients may be present in the compositions in quantities that are generally from 0.01 to 15 weight %, preferably from 0.01 to 10 weight %, so long as they do not result in a significant adverse effect on the compression and/or moisture resistance of the composition. Typically, many such additives may be present at levels of from 0.01 to 5 weight % or 0.01 to 1.0 weight %, based on the total weight of the composition.

The optional incorporation of such conventional ingredients into the compositions may be carried out by any known process, such as, for example, by dry blending, by extruding a mixture of the various constituents, by the conventional masterbatch technique, or the like.

Selection of Materials for Compression, Moisture Resistance and Resilience

The compositions described herein can provide tailored resiliency as indicated by the coefficient of restitution (COR). Coefficient of restitution is measured by firing a sphere that is 1.50 to 1.68 inches in diameter at an initial velocity of 125 feet/second against a steel plate positioned 3 feet from the point where initial velocity is determined and dividing the velocity of rebound from the plate by the initial velocity. COR may be determined on a sphere prepared from a single composition or a sphere having two or more layers (for example, a finished golf ball). A composition as described herein, when formed into such a sphere, may have a coefficient of restitution of greater than about 0.7, preferably greater than about 0.75, and more preferably greater than about 0.78.

The compositions may be highly resilient, that is, characterized by high COR values. More specifically, the composition may provide COR measurements in the range of from about 0.8 to about 0.9 or higher when measured according to the COR Method described herein. Any COR value from about 0.8 to about 0.9 or higher can be considered as “high COR”. The COR values (from about 0.8 to about 0.9) are for spheres prepared from the composition without filler.

Another measure of resilience is the “loss tangent,” or tan A, which is obtained when measuring the dynamic stiffness of an object. Loss tangent and terminology relating to such dynamic properties is typically described according to ASTM D4092-90. Thus, a lower loss tangent indicates a higher resiliency, thereby indicating a higher rebound capacity. Low loss tangent indicates that most of the energy imparted to a golf ball from the club is converted to dynamic energy, i.e., launch velocity and resulting longer distance. The rigidity or compressive stiffness of a golf ball may be measured, for example, by the dynamic stiffness. A higher dynamic stiffness indicates a higher compressive stiffness. To produce golf balls having a desirable compressive stiffness, the dynamic stiffness of the material should be less than about 50,000 N/m at −50° C. For example, the dynamic stiffness should be between about 10,000 and 40,000 N/m at −50° C., or between about 20,000 and 30,000 N/m at −50° C.

The selection of compositions with specific combinations of compression, moisture resistance and resilience will in large part be dependent upon the type of golf ball desired (i.e., one-piece, two-piece, wound, and multilayer), and in the type of performance desired for the resulting golf ball as detailed below.

Golf Ball Construction

The compositions as described herein may be used with any type of ball construction. Golf balls can be divided into two general classes: wound and solid. Wound golf balls typically include a solid, hollow, or fluid-filled center, surrounded by windings of a tensioned elastomeric thread-like material, and a cover. Since early wound balls had three parts (center, windings and cover), wound balls also may be referred to as “three-piece” balls, even if the cover and/or center comprise more than one layer. Solid golf balls include one-piece, two-piece (i.e., solid core and a cover), and multilayer (i.e., a core of one or more layers, one or more intermediate layers and/or a cover of one or more layers) golf balls. As used herein, the term “solid golf ball” also includes a ball comprising a hollow or fluid-filled center surrounded by one or more of solid layers.

The golf ball can have an overall diameter of any size. Although the United States Golf Association (“USGA”) specifications limit the minimum size of a competition golf ball to 1.680 inches, there is no specification as to the maximum diameter. Golf balls of any size, however, can be used for recreational play. The preferred diameter of the present golf balls is from about 1.680 inches to about 1.800 inches. The more preferred diameter is from about 1.680 inches to about 1.760 inches. The most preferred diameter is about 1.680 inches to about 1.740 inches.

Golf balls wherein at least one layer of the golf ball comprises the composition described herein are contemplated. For example, the composition may be used in cores or centers of one-piece, two-piece, wound, and multilayer golf ball designs, including golf balls having double cores (a core comprising two parts or layers such as an inner core and an outer core), intermediate layer(s), and/or double covers (a cover comprising two parts or layers such as an inner cover and an outer cover). As known to those of ordinary skill in the art, the type of golf ball constructed, i.e., double core, double cover, and the like, depends on the type of performance desired of the ball. As used herein, the term “layer” includes any substantially spherical or spherically symmetrical portion of a golf ball, i.e., a golf ball core or center, an intermediate layer, and/or a golf ball cover. As used herein, the term “inner layer” refers to any golf ball layer beneath the outermost structural layer of the golf ball. As used herein, “structural layer” does not include a coating layer, top coat, paint layer, or the like. As used herein, the term “multilayer” without specifying a number refers to a golf ball with at least three structural layers comprising a cover, intermediate layer and core.

Golf balls generally have surface contouring to affect their aerodynamic performance. This surface contouring is typically embodied by a plurality of small, shallow depressions (“dimples”) molded into the otherwise spherical surface of the golf ball. The dimples can be arranged in any one of a number of patterns to modify the flight characteristics of the balls. For example, the surface contouring of the golf ball may be a conventional dimple pattern such as disclosed in U.S. Pat. No. 6,213,898. Another dimple pattern, consisting of a plurality of dimples of various sizes for providing an optimum impact at the moment of hitting the golf ball, is disclosed in US Patent Application Publication 2006/0276267. Golf balls of this invention may have dimple coverage greater than about 60 percent, or greater than about 65 percent, or greater than about 75 percent of the surface area of the cover. Alternatively, the surface contouring of the golf ball may have a non-dimple pattern such as disclosed in U.S. Pat. No. 6,290,615. Any surface contouring or dimple pattern is contemplated for the golf balls described herein and is not limited to the dimple patterns disclosed in these references.

Golf balls typically comprise concentric layers of materials in their construction. The outermost layer of a golf ball is known as the cover. Covers can be made from any conventional golf ball cover material such as ionomer resin, balata rubber or thermoset/thermoplastic polyurethanes and the like and include the surface contouring or dimple pattern. Covers may also be prepared from the compositions described herein. The covers can be made by injection or compression molding a cover composition over a thermoplastic or thermoset core for a two-piece golf ball, over windings around a thermoplastic or thermoset center for a wound golf ball, or as the outermost layer of a multilayer golf ball. For example, cover layers may be from about 0.005 inch to about 0.15 inch in thickness.

The cover may be coated, e.g. with a urethane lacquer, painted or otherwise finished for appearance purposes, but such a coating, painting and/or finishing generally does not have a significant effect on the performance characteristics of the ball. Therefore, coatings, paints and finishes applied to the cover of a golf ball are not within the meaning of the term “layer” as used herein.

Prepolymers used for polyurethanes for covers are produced by combining at least one polyol, such as a polyether, polycaprolactone, polycarbonate or a polyester, and at least one isocyanate. Thermoset polyurethanes are obtained by curing at least one polyurethane prepolymer with a curing agent selected from a polyamine, triol or tetraol. Thermoplastic polyurethanes are obtained by curing at least one polyurethane prepolymer with a diol curing agent. The choice of the curatives may be important because some urethane elastomers that are cured with a diol and/or blends of diols do not produce urethane elastomers with the impact resistance desired in a golf ball cover. Blending the polyamine curatives with diol-cured urethane elastomeric formulations may provide thermoset urethanes with improved impact and cut resistance.

Covers for golf balls comprising the moisture resistant, thermoplastic described above are included in the invention. The covers can be made by injection or compression molding the moisture resistant, thermoplastic composition described above (with or without filler, other components, and other thermoplastics including other ionomers) over a thermoplastic or thermoset core of a two-piece golf ball, over windings around a thermoplastic or thermoset center, or as the outer layer of a multilayer golf ball.

The innermost layer is known as the center or core. The core may be solid, hollow, or filled with a fluid, such as a gas or liquid, or have a metal layer. The core can be prepared from conventional core materials (including thermoset compositions such as polybutadiene rubber) or it can be prepared from a composition as described herein. A solid core is prepared from a composition that is injection-molded or compression-molded into a substantially spherical or spherically symmetrical solid. Cores may be spherical or they may have a more complex spherically symmetrical shape (for example, comprising a central portion and a plurality of projections and/or depressions). For example but not limitation, cores with complex shapes are disclosed in US Patent Application Publication 2004/0209705. The core may be surface treated by plasma treatment, corona discharge, chemical treatment or mechanically treated. The core has an average diameter such that the thickness of the cover and any additional layers can be added to the diameter of the core to provide a golf ball of desired size, for example, at least about 1.68 inches in diameter.

Conventional core materials may include a base rubber, a crosslinking agent, a filler, and a co-crosslinking or initiator agent. The base rubber typically includes natural or synthetic rubbers. An example base rubber is 1,4-polybutadiene having a cis-structure of at least 40%. Preferably, the base rubber comprises high-Mooney-viscosity rubber. If desired, the polybutadiene can also be mixed with other elastomers known in the art such as natural rubber, polyisoprene rubber and/or styrene-butadiene rubber in order to modify the properties of the core. The crosslinking agent may include a metal salt of an unsaturated fatty acid such as a zinc salt or a magnesium salt of an unsaturated fatty acid having 3 to 8 carbon atoms such as acrylic or methacrylic acid. Suitable cross linking agents include metal salt diacrylates, dimethacrylates and monomethacrylates wherein the metal is magnesium, calcium, zinc, aluminum, sodium, lithium or nickel. The crosslinking agent may be present in an amount from about 15 to about 30 parts per hundred of the rubber, preferably in an amount from about 19 to about 25 parts per hundred of the rubber and most preferably having about 20 to 24 parts crosslinking agent per hundred of rubber. The core compositions may also include at least one organic or inorganic cis-trans catalyst to convert a portion of the cis-isomer of polybutadiene to the trans-isomer, as desired. The initiator agent can be any known polymerization initiator which decomposes during the cure cycle. Suitable initiators include peroxide compounds such as dicumyl peroxide, 1,1-di-(t-butylperoxy) 3,3,5-trimethyl cyclohexane, a-a bis-(t-butylperoxy)diisopropylbenzene, 2,5-dimethyl-2,5 di-(t-butylperoxy)hexane or di-t-butyl peroxide and mixtures thereof.

Intermediate layers between the cover and the core also may be known as “mantles”. An intermediate layer may also be referred to as an “inner cover” or an “outer core” or a “boundary layer.” These intermediate layers may form a substantially spherical or spherically symmetrical shell around the core. For example, intermediate layers may have a plurality of projections and/or depressions that are complementary to any projections and/or depressions in the other layers of the golf ball, such as in the outer surface of the core and/or the inner face of the cover. “Mantle” or “boundary layer” can refer to a relatively thin layer, for example, from about 0.20 inch to about 0.075 inch in thickness, in contact with the inner face of the cover layer. The intermediate layer may comprise ionomeric materials and/or non-ionomeric materials including, but are not limited to, metallocene catalyzed polyolefins or polyamides, polyamide/ionomer blends, polyphenylene ether/ionomer blends, etc. Other suitable materials include but are not limited to, thermoplastic or thermosetting polyurethanes, thermoplastic block polyesters, for example, a polyester elastomer such as that marketed by DuPont under the brand HYTREL, or thermoplastic block polyamides, for example, a polyether amide such as that marketed by Elf Atochem S. A. under the brand PEBEX, a blend of two or more non-ionomeric thermoplastic elastomers, or a blend of one or more ionomers and one or more non-ionomeric thermoplastic elastomers. These materials can be blended with ionomers in order to reduce cost relative to the use of higher quantities of ionomer. Mantles or intermediate layers may also be prepared from the compositions described herein.

Of note are golf balls comprising (a) a cover prepared from polyurethane; and (b) an additional structural layer comprising any of the compositions described herein, wherein the additional structural layer is selected from the group consisting of mantle, intermediate layer, outer core, inner core, single core, and center.

Of note are mantle or intermediate layers comprising or prepared from the moisture resistant thermoplastic compositions described herein. For example, the mantle may be prepared from a composition comprising an organic acid that is saturated and linear; and an ethylene dipolymer as described above wherein greater than 50 mole % of all the acid moieties of the acid and dipolymer are neutralized to salts comprising at least about 75 equivalent % Ca counterions or at least about 30 equivalent % Zn counterions having a PGA Compression equal to or greater than 110.

Also of note for preparation of mantles is the moisture resistant thermoplastic composition having a PGA compression less than 110 that comprises or is prepared from an organic acid that is branched and saturated, branched and unsaturated; or linear and unsaturated; and an E/X/Y terpolymer, as described above, wherein greater than 70 mol % of all the acid moieties of the organic acid and the terpolymer are neutralized to salts comprising at least about 30 equivalent % zinc counterions.

One-Piece Golf Ball Preferred Embodiments

One-piece balls can be made by well-known injection or compression molding techniques. They will have surface contouring as described above and may be coated with a urethane lacquer, painted or finished for appearance purposes, but such coating, painting and/or finishing will not significantly affect the performance characteristics of the ball.

The one-piece ball is made by injection or compression molding a substantially spherical shape of desired size, including surface contouring, from a moisture resistant, thermoplastic composition described above that is optionally filled with sufficient filler to provide a golf ball meeting the weight limits (45 grams) set by the PGA. Preferably, enough filler is used so that the ball has a density of 1.14 gm/cc.

Two-Piece Golf Ball Preferred Embodiments

Two-piece balls are manufactured by well-known techniques wherein covers are injection or compression molded over cores. The core of a two-piece ball is made by injection or compression molding a substantially spherical or spherically symmetrical solid of desired size and shape from the moisture resistant, thermoplastic composition that is optionally filled with sufficient filler to provide a desired core density. Desirable core density can be, for example, from about 1.14 g/cc to about 1.2 g/cc, depending on the diameter of the core and the thickness and composition of the cover to produce a golf ball meeting the weight limits (45 grams) set by the PGA.

Of note for preparation of these cores is the thermoplastic composition having a PGA compression less than 110 that comprises or is prepared from an organic acid that has from 19 to 36 carbon atoms and is unsaturated and linear, or that has from 6 to 36 carbon atoms and is branched and saturated or branched and unsaturated and wherein greater than 70 mol % of all the acid moieties of the organic acid and the terpolymer are neutralized to salts. Also of note for preparation of these cores is the moisture resistant thermoplastic composition having a PGA compression less than 110 that comprises or is prepared from an organic acid that is branched and saturated, branched and unsaturated; or linear and unsaturated; and an E/X/Y terpolymer, as described above, wherein greater than 70 mol % of all the acid moieties of the organic acid and the terpolymer are neutralized to salts comprising at least about 40 equivalent % zinc counterions.

Wound Golf Ball Preferred Embodiments

Wound balls are manufactured by well known techniques as described in, e.g., U.S. Pat. No. 4,846,910. The center of wound balls is made by injection or compression molding a solid (optionally hollow or fluid-filled) of desired size and shape from a thermoplastic composition described above that is optionally filled with sufficient filler to provide a desired center density depending on the diameter of the center, the windings, and the thickness and composition of the cover to produce a golf ball meeting the weight limits (45 grams) set by the PGA. The size and shape of the center is such that it can be wound with elastomeric material. The windings may be any elastomeric material conventionally used in wound golf balls and are wound around the center. Covers are then injection or compression molded over the windings. The cover may comprise a thermoplastic, preferably moisture-resistant, composition described above.

Of note for preparation of centers or covers of would balls is the thermoplastic composition having a PGA compression less than 110 that comprises or is prepared from an organic acid that has from 19 to 36 carbon atoms and is unsaturated and linear, or that has from 6 to 36 carbon atoms and is branched and saturated or branched and unsaturated and wherein greater than 70 mol % of all the acid moieties of the organic acid and the terpolymer are neutralized to salts. Also of note for preparation of the centers or covers is the moisture resistant thermoplastic composition having a PGA compression less than 110 that comprises or is prepared from an organic acid that is branched and saturated, branched and unsaturated; or linear and unsaturated; and an E/X/Y terpolymer, as described above, wherein greater than 70 mol % of all the acid moieties of the organic acid and the terpolymer are neutralized to salts comprising at least about 40 equivalent % zinc counterions.

Multilayer Golf Ball Preferred Embodiments

Multilayer balls are manufactured by well-known techniques wherein an injection or compression molded core is covered by one or more intermediate layers or mantles and a cover by injection or compression molding. The various layers of a ball (that is, the core, the mantle(s), intermediate layers and/or cover) are made by injection or compression molding a substantially spherical or spherically symmetrical core and sequentially injection or compression molding additional layers of desired size or thickness, optionally filled with sufficient filler to provide a golf ball meeting the size and weight limits (45 grams) set by the PGA. Multilayer golf balls of this invention comprise at least one layer prepared from a thermoplastic composition described herein, optionally comprising filler. The amount of filler employed in the core, mantle(s) and/or intermediate layers can be varied from 0 to about 60 weight % depending on the size (thickness) of the components and the desired location of the weight in the ball, provided that the final ball meets any desired or required weight limits. The filler can be used in the core and not in the mantle and/or intermediate layer, in the mantle and/or intermediate layer and not in the core, or in all layers other than the cover. While not intending to be limiting as to possible combinations, this embodiment includes:
1. a core comprising a composition as described herein with a mantle and/or intermediate layer made of any composition known in the art,
2. a core comprising a composition as described herein used in the two-piece core or wound ball center with a mantle and/or intermediate layer made of a composition as described herein with or without filler adjusted to provide a golf ball of the desired weight,
3. a core made of any composition known in the art (including thermoset compositions such as polybutadiene rubber) with a mantle and/or intermediate layer comprising the composition as described herein with or without filler provided that the weight of the finished golf ball meets the required limit.

The following examples are provided to describe the invention in further detail. These examples, which set forth a preferred mode presently contemplated for carrying out the invention, are intended to illustrate and not to limit the invention.

### EXAMPLES

Analytical Methods

Coefficient of Restitution (COR) is measured by firing an injection-molded neat sphere of the resin having the size of a golf ball from an air cannon at a velocity determined by the air pressure. The initial velocity generally employed is 125 feet/second. The sphere strikes a steel plate positioned three feet away from the point where initial velocity is determined, and rebounds through a speed-monitoring device located at the same point as the initial velocity measurement. The return velocity divided by the initial velocity is the COR.

PGA Compression is measured as described above. Specifically, the Atti Compression Gauge is designed to measure the resistance to deformation or resistance to compression of golf balls that are 1.680 inches in diameter. In these examples, smaller spheres approximately 1.53 inches in diameter were used. Spacers or shims were used to compensate for this difference in diameter. The sphere diameters were measured. A shim thickness was calculated such that the sphere diameter plus shim thickness equaled 1.680 inches. Then the PGA compression of the sphere and shim was measured. A set of shims of different thicknesses were used to correct the sphere diameter plus shim thickness to within 0.0025 inches of 1.680 inches. After the PGA compression measurement was made, the value was mathematically corrected to compensate for any deviation from 1.680 inches. If the sphere diameter plus shim thickness was less than 1.680 inches, for every 0.001 inch less than 1.680 inches, 1 compression unit was added. If the sphere diameter plus shim thickness was greater than 1.680 inches, for every 0.001 inch greater than 1.680 inches, 1 compression unit was subtracted.

Water vapor transmission rate (WVTR) is measured on films having a thickness of 1 to 3 mils using MOCON Permatran-W700 test equipment. The rate of moisture diffusion through the film was measured using the protocols of ASTM F1249 under specific test conditions. This test uses a diffusion cell with “wet” and “dry” chambers. The dry chamber or diffusion cell was swept with a gas having <0.001% relative humidity (RH), and the wet chamber was held at 100% RH for the tests. Both sides of the film were held at 37.8° C. and atmospheric pressure. The resulting water vapor transmission rate was normalized to 1 mil by dividing the test result by the film thickness in mil.

Weight gain on exposure to moisture is determined by weighing a fixed amount of resin pellets, exposing the resin pellets to 50% relative humidity and ambient temperature for 90 days, and reweighing the pellets. The amount of weight gain due to moisture is calculated as a percentage. The pellet size is about 3 mm long and about 2 to 3 mm in diameter for the circular cross section.

As used in the Examples below, melt index (MI) refers to melt index as determined according to ASTM D1238, measured at 190° C. using a 2160 g weight, with values of MI reported in g/10 minutes.

Materials Used:

EAC-1: an ethylene n-butyl acrylate (nBA) acrylic acid (AA) terpolymer having 28 wt. % nBA and 6.2 wt. % M, with MI of 200.

EAC-2: an ethylene n-butyl acrylate (nBA) acrylic acid (AA) terpolymer having 23.5 wt. % nBA and 9 wt. % M, with MI of 200.

EAC-3: an ethylene acrylic acid (AA) dipolymer having 15.4 wt. % AA, with MI of 60.

EAC-4: an ethylene n-butyl acrylate (nBA) acrylic acid (M) terpolymer having 15.5 wt. % nBA and 10.5 wt. % M, with MI of 60.

Masterbatch-1: A Mg(OH)₂ concentrate with 50 weight % Mg(OH)₂ in EAC-1.

Masterbatch-2: A ZnO concentrate with 45 weight % ZnO in an ethylene/methacrylic acid dipolymer having 10 weight % of methacrylic acid.

### Examples 1 to 4 and Comparative Examples C1 to C3

The components of the blends of Comparative Examples C1 to C3 and Examples 1 to 4 are set forth in Table 1, below. These blends were prepared according to the following general procedure.

Employing a Werner & Pfleiderer twin screw extruder, an organic acid, an ethylene acid copolymer, and a neutralizing agent were melt blended. The amounts of the acid and copolymer were added so that the resulting blend contained 40 weight % of the organic acid. The blends included an amount of Mg(OH)₂ or Masterbatch-1 that was in excess of the stoichiometric amount required to nominally neutralize 100% of the acid moieties of the organic acid and the acid copolymer. For comparative Example C1, the neutralizing agent was Materbatch-1. For the other examples and comparative examples that are listed in Table 1, Mg(OH)₂ powder was the neutralizing agent.

Depending on the effectiveness of mixing an individual batch by melt extrusion, the actual degree of neutralization for a given compositional mixture could vary slightly and thus lead to slight variations in the resultant properties. For example, C1 and C3 (see Table 1) have different MI's despite having the same nominal neutralization level, suggesting that the actual extent of neutralization of the two samples may be different.

The compositions were molded into spheres as described below, and their PGA Compression and Coefficient of Restitution were measured. The results are reported in Table 1.

TABLE 1

| | Example | | | | | | |
|---|---|---|---|---|---|---|---|
| | C1 | 1 | C2 | 2 | C3 | 3 | 4 |
| Resin | EAC-1 | EAC-1 | EAC-2 | EAC-2 | EAC-1 | EAC-1 | EAC-1 |
| Organic Acid | Oleic | Erucic | Oleic | Erucic | Oleic | Iso-Oleic | Iso-Stearic |
| Acid Length* | 18 | 22 | 18 | 22 | 18 | 18 | 18 |
| MI at 190° C. | 3.1 | 2.3 | 1.2 | 1.2 | 0.8 | 2.2 | 0.9 |
| Compression | 67 | 35 | 70 | 59 | 70 | 38 | 48 |
| COR-125 | 0.798 | 0.775 | 0.809 | 0.801 | 0.803 | 0.778 | 0.778 |

*“Acid Length” is the number of carbon atoms in the organic acid.

Comparison of the results for Comparative Examples C1 and C2, containing oleic acid, with the results for Examples 1 and 2, containing erucic acid, show that the longer linear, unsaturated acids provide a significant decrease in PGA Compression values. The branched acids, whether unsaturated (Example 3) or saturated (Example 4), also provide a significant decrease in PGA Compression values.

### Examples 5 to 9

The components of the blends of Examples 5 to 9 are set forth in Table 2, below. These blends were prepared according to the following procedures.

Employing a Werner & Pfleiderer twin screw extruder, an organic acid, or an organic acid salt, and the ethylene acid copolymer EAC-3 were melt blended with Ca(OH)₂ powder. The components were fed at the hopper of the extruder. For Examples 5 to 8, the blends included an amount of Ca(OH)₂ that was stoichiometrically sufficient to attain 53 to 70% nominal neutralization of the combined acid moieties of the organic acid or salt and the acid copolymer in the final products.

Example 9 was prepared by melt blending, in a Werner & Pfleiderer twin screw extruder, Blend A and Blend B at a ratio of 40 parts to 60 parts by weight. Blend A was prepared by melt blending EAC-3 with 20% zinc stearate and a stoichiometric amount of Masterbatch-2 in a Werner & Pfleiderer twin screw extruder to achieve an overall nominal neutralization of 57.7%. Blend B was prepared by melt blending EAC-3 with 30% Ca stearate and a stoichiometric amount of Ca(OH)₂ in a Werner & Pfleiderer twin screw extruder to achieve an overall nominal neutralization of 68.7%.

The compositions were molded into spheres as described below and their PGA Compression, weight gain due to moisture absorption and Coefficient of Restitution were measured. The results are reported in Table 2.

TABLE 2

| | Example | | | | |
|---|---|---|---|---|---|
| | 5 | 6 | 7 | 8 | 9 |
| Resin | EAC-3 | EAC-3 | EAC-3 | EAC-3 | EAC-3 |
| Organic Acid or | 20% | 18% | 20% | 30% | 8% Zn |
| Salt | Ca | Ca | Behenic | Behenic | Stearate |
| | Stearate | Stearate | acid | acid | and |
| | | | | | 18% Ca |
| | | | | | Stearate |
| Counter-ion | Ca | Ca | Ca | Ca | Ca and Zn |
| Acid Length | 18 | 18 | 22 | 22 | 18 |
| MI at 190° C. | 1.7 | 1.8 | 1.7 | 0.51 | 3.3 |
| Compression | 159 | 156 | 157 | 157 | 160 |
| COR-125 | 0.8 | 0.794 | 0.805 | 0.833 | 0.803 |
| % Weight Gain | NA | 0.51% | 0.45% | 0.52% | 0.49% |

The results in Table 2 demonstrate that the compositions have very low weight gain, less than 0.6%, upon exposure to moisture. The compositions also exhibit high PGA Compression numbers, indicating that the compositions are stiff.

### Comparative Example C10 and Examples 11 to 15

Comparative Example C10 was prepared by melt blending 52.8 weight % of EAC-4, 35 weight % of oleic acid and 12.2 weight % of Masterbatch-1 in a Werner & Pfleiderer twin screw extruder.

Example 11 was prepared was prepared by melt blending 48.3 weight % of EAC-4, 31.9 weight % of oleic acid and 19.7 weight % of Masterbatch-1 in a Werner & Pfleiderer twin screw extruder.

Examples 12-15 were prepared by melt blending, in a Werner & Pfleiderer twin screw extruder, portions of Comparative Example C10 and Example 11 at the blend ratios indicated in Table 3.

The compositions were molded into spheres as described below and their PGA Compression, weight gain due to moisture absorption and Coefficient of Restitution were measured. The results are reported in Table 3.

TABLE 3

| | Example | | | | | |
|---|---|---|---|---|---|---|
| | C10 | 11 | 12 | 13 | 14 | 15 |
| Ratio of C10 | 100:0 | 0:100 | 70:30 | 50:50 | 40:60 | 30:70 |
| to 11 (parts by | | | | | | |
| weight) | | | | | | |
| Counter-ion | Mg | Zn | Mg/Zn | Mg/Zn | Mg/Zn | Mg/Zn |
| MI at 190° C. | 0.70 | 0.37 | 0.54 | 0.61 | 0.75 | 1.22 |
| Compression | 88 | 106 | 97 | 103 | 99 | 89 |
| COR-125 | 0.858 | 0.756 | 0.824 | 0.825 | 0.820 | 0.815 |
| % Weight Gain | 4.33 | 0.44 | 2.00 | 1.54 | 1.22 | 0.94 |

Comparative Example C10, which includes no zinc cations, exhibited a significant weight gain (4.33%) upon exposure to moisture, while Examples 11-15, compositions with at least 30 equivalent % of zinc, exhibited a weight gain of less than or equal to 2.00%.

Thermoplastic Spheres

Extrusion conditions for making the blends described in Tables 1 through 3 are set forth in Table 4.

TABLE 4
Extrusion Conditions

| | | | | | | Vac- |
|---|---|---|---|---|---|---|
| Screw | Zone 1 | | | | | uum |
| Speed | Temp | Zone 2-3 | Zone 4-9 | Die | Rate | (inch- |
| Rpm | ° C. | Temp ° C. | Temp ° C. | Temp ° C. | (lb/hr) | es) |
| 100-300 | 75-140 | 90-160 | 140-240 | 200-230 | 10-30 | 28 |

Molding conditions for making spheres that are 1.53 inches in diameter are given in Table 5.

TABLE 5
Molding Conditions for Spheres

| | | Injection | | | |
|---|---|---|---|---|---|
| Temperature | | Pressures | | Cycle Times | |
| (° C.) | | (Kg/cm²) | | (sec) | |
| Rear | 183 | Ist Stage | 130 | Pack | 10 |
| Center | 173 | 2nd Stage | 110 | Hold | 480 |
| Front | 173 | Hold | 13 | Booster | 10 |
| Nozzle | 177 | | | Cure Time | 15 |
| Mold Front/Back | 10 | | | Screw Retraction | 5.35 |
| Melt | 195 | | | | |

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A moisture-resistant composition comprising:
(a) at least one aliphatic, mono-functional organic acid comprising up to 36 carbon atoms, wherein the organic acid is saturated and linear; and
(b) an ethylene acid copolymer consisting essentially of copolymerized monomers of ethylene and from 4 to 30 weight % of copolymerized comonomers of at least one C₃ to C₈ α,β ethylenically unsaturated carboxylic acids, based on the total weight of the ethylene dipolymer;
wherein greater than 50 mole % of all the acid moieties of (a) and (b) are neutralized to form salts;
wherein the cations of the salts comprise at least about 75 equivalent % of Ca²⁺ cations or at least about 30 equivalent % of Zn²⁺ cations, based on the total number of moles of salts;
wherein pellets of the moisture-resistant composition about 3 mm long and about 2 to 3 mm in diameter gain 2.0% or less in weight after exposure to 50% relative humidity at ambient temperature for 90 days;
and wherein the composition has a PGA Compression equal to or greater than 110.

2. The moisture-resistant composition of claim 1 wherein the organic acid comprises 6 or more carbon atoms.

3. The moisture-resistant composition of claim 2 wherein the organic acid comprises stearic acid or behenic acid.

4. The moisture-resistant composition of claim 2 comprising from about 4 to about 30 weight % of calcium stearate or calcium behenate, based on the total weight of the moisture resistant composition.

5. The moisture-resistant composition of claim 1 wherein the ethylene acid copolymer comprises from about 10 to about 25 weight % of copolymerized comonomers of the C₃ to C₈ α,β ethylenically unsaturated carboxylic acids, based on the total weight of the ethylene acid copolymer.

6. The moisture-resistant composition of claim 1 wherein the C₃ to C₈ α,β ethylenically unsaturated carboxylic acid comprises acrylic acid or methacrylic acid.

7. A moisture-resistant composition comprising
(a) at least one aliphatic, mono-functional organic acid comprising up to 36 carbon atoms; wherein the organic acid is branched or linear; and wherein the organic acid is saturated or unsaturated; and
(b) an E/X/Y copolymer, wherein E represents copolymerized monomers of ethylene, X represents copolymerized monomers of at least one C₃ to C₈ α,β ethylenically unsaturated carboxylic acid and Y represents copolymerized monomers of at least one alkyl acrylate or alkyl methacrylate, wherein the alkyl group comprises from one to eight carbon atoms; wherein X is present in the terpolymer in an amount of from about 2 to about 25 weight % and Y is present in the terpolymer in an amount of from about 1 to about 40 weight %, based on the total weight of the E/X/Y terpolymer;
wherein greater than 70 mol % of all the acid moieties of (a) and (b) are neutralized to form salts;
wherein the cations of the salts comprise at least about 30 equivalent % of Zn²⁺ cations;
wherein pellets of the moisture-resistant composition about 3 mm long and about 2 to 3 mm in diameter gain 2.0% or less in weight after exposure to 50% relative humidity for 90 days;
and wherein the moisture-resistant composition has a PGA Compression of less than 110.

8. The moisture-resistant composition of claim 7 wherein X is present in the terpolymer in an amount from about 4 to about 15 weight %.

9. The moisture-resistant composition of claim 7 wherein Y is present in the terpolymer in an amount from about 5 to about 35 weight %.

10. The moisture-resistant composition of claim 7 wherein X represents copolymerized monomers of acrylic acid or methacrylic acid.

11. The moisture-resistant composition of claim 7 wherein the neutralized organic acid is present in an amount of from about 4 to about 50 weight %, based on the total weight of the moisture-resistant composition.

12. The moisture-resistant composition of claim 7 wherein the organic acid is branched and saturated, branched and unsaturated, or linear and unsaturated.

13. The moisture-resistant composition of claim 12 wherein the organic acid comprises 6 or more carbon atoms.

14. The moisture-resistant composition of claim 13 wherein the organic acid is branched and saturated and comprises from 6 to 24 carbon atoms, wherein the organic acid is branched and unsaturated and comprises from 6 to 24 carbon atoms, or wherein the organic acid is linear and unsaturated and comprises from 6 to 17 or from 19 to 36 carbon atoms

15. The moisture-resistant composition of claim 13 wherein the organic acid comprises iso-stearic acid, iso-oleic acid, oleic acid or erucic acid.

16. A composition comprising:
(a) at least one aliphatic, mono-functional organic acid, wherein the organic acid has from 19 to 36 carbon atoms and is unsaturated and linear, or wherein the organic acid has from 6 to 36 carbon atoms and is branched and saturated or unsaturated; and
(b) an E/X/Y copolymer, wherein E represents copolymerized comonomers of ethylene, X represents copolymerized monomers of at least one C₃ to C₈ α,β ethylenically unsaturated carboxylic acid and Y represents copolymerized comonomers of at least one alkyl acrylate or alkyl methacrylate, wherein the alkyl group comprises one to eight carbon atoms; and wherein X is present in the terpolymer in an amount of from 2 to 25 weight % and Y is present in the terpolymer in an amount of from 1 to 40 weight %, based on the total weight of the E/X/Y terpolymer;
wherein greater than 70 mol % of all the acid moieties of (a) and (b) are neutralized to form salts;
and wherein the composition has a PGA compression less than 110.

17. The composition of claim 16 wherein the neutralized organic acid is present in an amount of from about 4 to about 50 weight %, based on the total weight of the composition.

18. The composition of claim 16 wherein X is present in the terpolymer in an amount of from about 4 to about 15 weight %.

19. The composition of claim 16 wherein Y is present in the terpolymer in an amount of from about 5 to about 35 weight %.

20. The composition of claim 16 wherein X represents copolymerized comonomers of acrylic acid or methacrylic acid.

21. The composition of claim 16 wherein the organic acid comprises erucic acid, iso-stearic acid or iso-oleic acid.

22. The composition of claim 16 wherein the organic acid comprises from 6 to 24 carbon atoms and is branched and saturated or unsaturated.

23. A golf ball comprising the moisture-resistant composition of claim 1.

24. The golf ball of claim 23 that is a one-piece ball, a two-piece ball, a wound ball, or a multilayer ball.

25. The golf ball of claim 23 comprising a structural layer prepared from the composition, wherein the structural layer is selected from the group consisting of a cover, a mantle, an intermediate layer, a casing layer, an outer core, an inner core, a single core, and a center; and optionally further comprising a cover prepared from polyurethane.

26. A golf ball comprising the moisture-resistant composition of claim 7.

27. The golf ball of claim 26 that is a one-piece ball, a two-piece ball, a wound ball, or a multilayer ball.

28. The golf ball of claim 26 comprising a structural layer prepared from the composition, wherein the structural layer is selected from the group consisting of cover, mantle, intermediate layers, casing layers, outer core, inner core, single core and center; and optionally further comprising a cover prepared from polyurethane.

29. A golf ball comprising the composition of claim 16.

30. The golf ball of claim 29 that is a one-piece ball, a two-piece ball, a wound ball, or a multilayer ball.

31. The golf ball of claim 29 comprising a structural layer prepared from the composition, wherein the structural layer is selected from the group consisting of cover, mantle, intermediate layer, casing layer, outer core, inner core, single core and center; and optionally further comprising a cover prepared from polyurethane.
